(19) United States
(12) Patent Application Publication
(10) Pub. No.: US 2020/0137994 A1
(43) Pub. Date: May 7, 2020

(54) Carbon fiber fishing lure

(71) Applicant: Robert T. Honiball, Kewick (CA)

(72) Inventor: Robert T. Honball, Kewick (CA)

(21) Appl. No.: 16/602,499

(22) Filed: Oct. 18, 2019

Related U.S. Application Data
(60) Provisional application No. 62/766,748, filed on Nov. 1, 2018.

(51) Int. Cl. A01K 85/14

(52) U.S. Cl. CPC A01K 85/14

(57) ABSTRACT

A fishing lure is constructed of a rigid plate of carbon fiber configured to simulate bait (e. g. fish, worm, insect, or cephalopod) for fish; at least one hook assembly attached to the carbon fiber plate; and a mechanism that allows connection of the plate to a fishing line. The carbon fiber of the plate may have a bi-directional/double weave. the carbon fibers forming the plate may have a thickness between about 4 and 12 μm, and the plate may have a thickness of between about 1.5-5 mm. The mechanism that allows connection of the plate to a fishing line may have a construction containing an adjustable lip and link assembly for attaching a fishing line including a V-shaped opening in the front of the plate, and slots in both the upper and lower surfaces defining the opening, the slots dimensioned and configured to hold a lip.

### CROSS-REFERENCE TO RELATED APPLICATION

This application claims the priority of provisional U.S. Application Ser. No. 62/766,748 filed Nov. 1, 2018, the disclosure of which is incorporated by reference herein.

### BACKGROUND AND SUMMARY OF THE INVENTION

There are thousands of different types of fishing lures on the market and in the literature. The goal for all fishing lures is, of course, to attract fish. After that the ease and expense of manufacture, aesthetic appeal to humans, durability, ease of use, and versatility are all important features. The carbon fiber fishing lure of the invention has desirable attributes with respect to each of these features.

The invention relates to a fishing lure made from a substantially rigid plate of carbon fiber (preferably a bi-directional/double weave, roughly 1.5-5 mm thick plate). While carbon fiber has been proposed in other fishing lures (e. g. see U S Published Application 2016/0015013 which simply includes carbon fiber in a long list of possible materials including wood, plastic and metal) the utilization has been much different than the utilization according to the invention. For example in U.S. Pat. No. 5,182,875 a thin flexible membrane is utilized in the core of the lure to provide a serpentine movement of the lure; the flexible membrane is a cloth like material such as aircraft fiber, or alternatively carbon fiber, or stainless steel mesh, specifically contrary to the substantially rigid plate of the invention.

Carbon fiber per se has a number of advantages over a typical lure made of plastic or wood. Carbon fiber is extremely strong and durable while many plastic or wood lures used to fish for predatory (toothy) fish may show bite marks which ultimately can weaken the integrity of the lure over time. Some plastic lures can actually break when miscast onto a rock or other hard surface (especially when fishing in cold temperatures) because of their brittle nature. Carbon fiber will not likely simply break on impact because of its multi-layer woven make up. Also, carbon fiber can be purchased in several weave patterns (plain weave, satin weave, twill weave, and basket weave) and different plate thicknesses which affect the rigidity and properties of the carbon fiber plate to suit different lure shapes specific to a certain type of targeted fish. Carbon fiber is available in a small variety of colors and in a range of different fiber thicknesses, 5.2 μm, 7 μm, 10 μm (1 μm=0.001 mm), to name a few. There is also a choice between a gloss or satin finish on the carbon fiber plate.

One of the most unique and unmistakable properties of carbon fiber is its reflective pattern. The weave (in bi-directional carbon fiber constructions) gives off a reflection not unlike fish scales and on two separate angles (one for the vertical fibers and one for the horizontal fibers) which appeals to many species of fish, hungry or not, because of the innate nature of many species of fish to strike at something flashy or distracting. Despite its strength and durability carbon fiber is very easy to cut, sand, drill, and otherwise machine, which makes it an easy material to work with.

Because of the simple design and flat profile of the lure according to the invention, many adaptations can be made to the overall shape of the lure as well as colors and patterns via decal kits that could be available separately to the end user and easy to apply. The variations and sizes are unlimited, and all embodiments can be manufactured easily without the need to re-tool or modify an injection mold as it is only a one sided cut from a carbon fiber plate.

Yet another advantage of the lure according to the invention is the adjustability of weight and weight placement. Holes can be machined into the body of the lure to hold specially designed weights tailoring the lure further to match fishing conditions. For example, a fisherman can add weights to get the lure deeper quicker when fishing deep water making the lure according to the invention completely customizable to the user by altering the lip, color, weight, and balance. Also, the lure of the invention has a simple construction for providing a replaceable lip which can facilitate the lure either diving, or surfacing.

The lure of the invention may be presented to fish in several different ways. Casting out and retrieving at a constant speed, casting and retrieving at a varied speed, random jerking of the lure to further imitate a wounded bait fish, or vertically jiggling the lure from directly above. The hardware added to the lip of the lure makes it front heavy and ensures the lure dives front first as is common among natural aquatic creatures and other lures fished with a reel-pause-reel method. The lip of the lure according to the invention is completely removable and can be switched out for different sizes and shapes affecting the action of the lure in the water.

According to one aspect of the invention, a fishing lure is provided comprising or consisting essentially of a substantially stiff (e. g. so that it does not flex in a serpentine manner when dragged through the water) carbon fiber plate with hook assemblies and a mechanism to attach it to a fishing line. The plate preferably has a thickness of about 1.5-5 mm, and the plate preferably has a bi-directional/double weave. The fibers forming the lure can have a thickness of between about 4 and 12 μm. As earlier indicated, attached to the plate are one or more conventional fishing hook assemblies, and the front of the lure provides a mechanism that is adapted to be connected to a fishing line. While the mechanism may be as simple as an opening in the lure, preferably the mechanism comprises a lip on the front of the lure that provides a connection to the fishing line. The lip is preferably readily replaceable so that it can have different orientations, sizes, and shapes to adapt to the conditions during fishing or the species of fish sought.

The carbon fiber plate may have openings formed therein for a variety of purposes. These purposes may include reduction in cost by reducing the amount of material; aesthetics; attractiveness to certain species of fish; and/or receipt of weights to adapt the lure to different water and desirable fish species circumstances.

According to another aspect of the invention a fishing lure is provided comprising a front portion having slots, one upwardly directed, the other downwardly directed, each slot for engaging a lip attachable to a fishing line. One lip is provided in a slot, and the lip may attach to a fishing line via a line link. A weight may be mounted in the lower slot.

It is the primary object of the present invention to provide an easy to construct, highly functional, and highly adaptable fishing lure. This and other objects of the invention will become clear from a detailed description of the invention and from the appended claims.

### BRIEF DESCRIPTION OF THE DRAWINGS

FIG. 1 is a side view of an exemplary fishing lure according to the invention with an optional weight shown in dotted line;

FIG. 2 is a top plan view of the lure of FIG. 1;

FIG. 3 is a front view of the lure of FIG. 1 and also showing a lower lip in addition to an upper lip; and

FIG. 4 is a schematic view of a sheet of various decals that may be utilized with the lure of FIGS. 1-3.

### DETAILED DESCRIPTION OF THE DRAWINGS

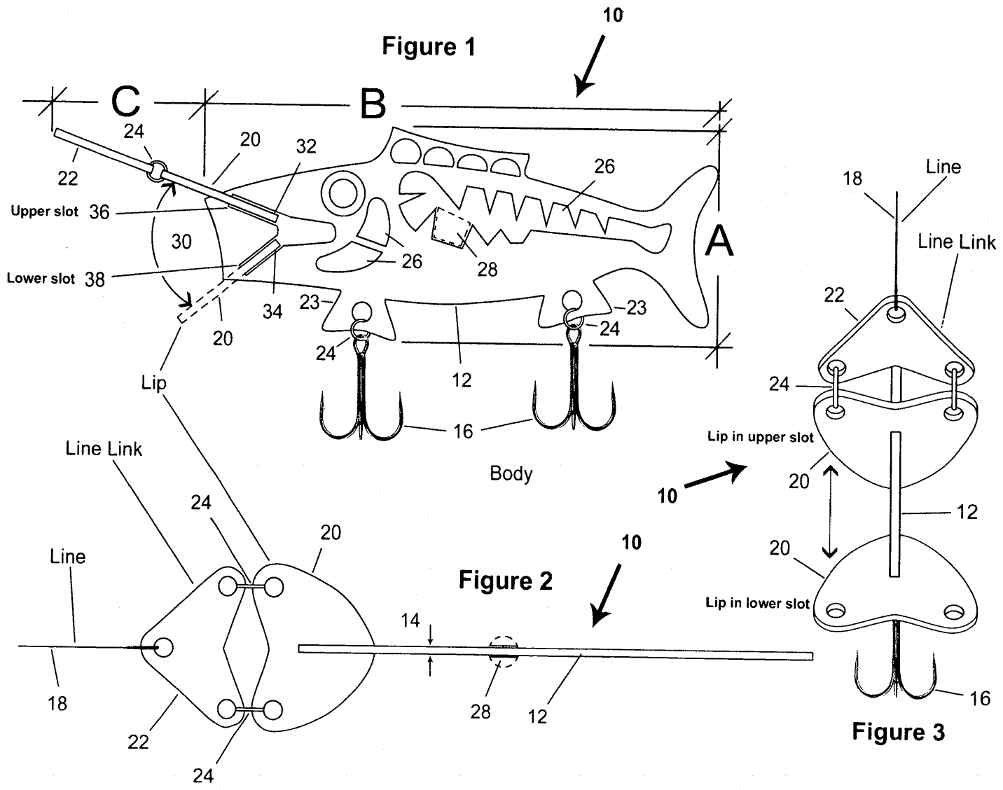

The exemplary fishing lure according to the invention illustrated in FIGS. 1-3 of the drawings is indicated generally by reference numeral 10. The major component of the lure 10 is the carbon fiber plate body 12. As seen in FIG. 1 the body 12 is desirably in the shape of bait, i. e. a creature that would entice a fish to strike it, such as a smaller fish (as illustrated), a worm, an insect, or a cephalopod. The body 12 preferably has a thickness 14 (see FIG. 2) of about 1.5-5 mm, so that it is substantially rigid and will not flex a significant amount if dragged through water. Most desirably, the plate 12 has a bi-directional/double weave. The fibers forming the plate 12 preferably have a thickness of between about 4 and 12 μm.

The characteristics for standard modulus carbon fibers having a thickness of 7 μm (other fiber thicknesses will yield different results) used to construct the body 12 (normalized to 60% fiber volume cured with #2500 epoxy at 130° C.) are:

FIBER PROPERTIES (7 μm)

| | | |
|---|---|---|
| PROPERTY | ENGLISH | METRIC |

| | | | | |
|---|---|---|---|---|
| Tensile Strength | 512 | ksi | 3,530 | MPa |
| Tensile Modulus | 33.4 | Msi | 230 | GPa |

| | |
|---|---|
| Strain at Failure | 1.5% |

| | | |
|---|---|---|
| Density | 1.76 | g/cm3 |
| Filament Diameter | 7 | μm |

COMPOSITE PROPERTIES (7 μm)

| | | |
|---|---|---|
| PROPERTY | ENGLISH | METRIC |

| | | | | |
|---|---|---|---|---|
| Tensile Strength* | 264 | ksi | 1,820 | MPa |
| Tensile Modulus* | 20 | Msi | 140 | GPa |

| | |
|---|---|
| Tensile Strain | 1.26% |

| | | | | |
|---|---|---|---|---|
| Compressive Strength* | 213 | ksi | 1,470 | MPa |
| Flexural Strength* | 260 | ksi | 1,790 | MPa |
| Flexural Modulus* | 18 | Msi | 123 | GPa |
| ILSS | 14 | ksi | 94.1 | MPa |
| In Plane Shear Strength | 14 | ksi | 95 | MPa |
| 90° Tensile Strength | 11 | ksi | 76 | MPa |

Operatively connected to the body 12 are one or a plurality (e. g. two) of conventional hook assemblies 16. The lure 10 also includes a front portion adapted to be connected to a fishing line 18. Preferably this is accomplished by a plate-like lip 20 on the front of the lure body 12 which provides a connection, desirably through a line link 22 attached by two metal rings 24 to the lip 20, the line link 22 connected directly to the fishing line 18. The lip 20 is preferably readily replaceable so that it can have different orientations, sizes, and shapes to adapt to the conditions during fishing or the species of fish sought. The lip 20, and line link 22, may be made of any desirable material including plastic, metal, or carbon fiber.

The carbon fiber plate 12 may have openings 26 formed therein for a variety of purposes. These purposes may include reduction in cost by reducing the amount of material; aesthetics; attractiveness to certain species of fish; and/or receipt of one or more weights to adapt the lure to different water and desirable fish species circumstances. A schematic illustration of a weight that may be utilized in an opening 26 is shown in dotted line at 28 in FIGS. 1 & 2. The weight 28 may be of any suitable material, including metal, hard plastic, and carbon fiber, and may have a friction fit or interference fit in an opening 26, or may be attached by a conventional water-resistant adhesive or by one or more conventional mechanical fasteners.

To provide desirable adjustability, the lip 20, or 20′ (FIG. 3) is removably attachable to the body 12 by any suitable means. In the preferred embodiment illustrated, the front of the body 12 has a generally V-shaped opening 30 defined by an upper surface 32 and a lower surface 34. The upper surface 32 has a slot 36 formed therein for the plate-like lip 20, and the bottom surface 34 has a slot 38 formed therein for receipt of the lip 20′ (see dotted line in FIG. 1 and solid line in FIG. 3). While FIG. 3, for ease of illustration, shows both lips 20, 20′ in slots 36, 38 respectively, during use typically only one of the lips 20, 20′ would be utilized (connected via link 22 to line 18).

The lip 20 can only be added or removed by utilizing the upper slot 32 in the lure body 12. The shape of the lower slot opening 34 is designed in such a way that the lip cannot be pulled back enough to allow removal; the upper slot 32 provides more clearance facilitating the removal and replacement of the lip. The idea of this feature is to minimize the opportunity of the lip to separate from the lure body 12 unintentionally. Furthermore, the openings 26 in the body 12 are purposefully shaped and oriented to prevent the hooks from unintentionally becoming lodged in the openings 26 and ‘fouling’ the action of the lure. The openings 26 are sized and placed based on the dimensions of a #2 round bend treble hook (16).

The fins 23 at the bottom of the lure 12 are sized in such a way to prevent the snap rings 24′ from ‘swinging’ around in front or behind the fin and giving the hooks more ‘reach’ to possibly become lodged in the openings 26 thus fouling the action of the lure.

The basic lure 10 may have other accessories associated therewith including enticement additives; spinners, bucktail plumes, and even the option to link several lures together to form a school of fish presentation

One exemplary (only, many dimensions are possible) for the lure 10 illustrated in FIG. 1 are: height A, about 45-60 mm (roughly 2.1 inches); length B, about 120-140 mm (roughly 5.25 inches); and length C about 30-45 mm (roughly 1.55 inches). The lure 10 may have almost any dimensions as long as the lure 10 can function as a fishing lure.

The steps for creating a carbon fiber plate 12 utilized according to the invention are straight forward and typically use only a few components, namely carbon fibre strands, catalyzed binding resin (two stage chemically hardening Epoxy Resin), compression, and heat. The actual manufacturing of those carbon fiber strands and ultimately rigid plates is a highly guarded secret among manufacturers as is the process to create them. But the basic techniques are known. Plates 12 can be purchased commercially.

In a typical manufacture of a plate 12, layers of interwoven carbon fiber cloth are saturated with resin and laid on top of each other until the desired thickness of carbon fiber plate requested is achieved, under pressure either by weight compression or by vacuum pressure (and heat to activate the catalyst). The layers are compressed until cured, the end result once cured is a flat consistent thickness of high quality carbon fiber plate 12 ready for use.

A commercially available carbon fiber plate 12 is used to produce a lure 10 according to the invention by executing a series of tasks using a range of software and equipment.

The first step is to create a vector file (a file that defines the look and shape of the item) in one of many available software applications (Adobe Illustrator, AutoCad, Fusion 360, etc). That vector file is then imported into an application (Vector Cut 2D Pro for example) that allows the producer to define the areas to be cut, drilled, bevelled, engraved, etc., and allows the export of these files (to .nc files or G-code) to be read by the next bit of software. That next software (Planet CNC in this case) reads the G-code coordinates (ex: N180X0.000Y0.000F2540.0) and translates those coordinates' movement into x (horizontal), y (longitude), and z (vertical) movements. A G-code list of coordinates can have potentially millions of lines of code depending on the complexity of the finished piece.

The culmination of these steps is a tangible item (lure 10) mimicking the original design As mentioned, carbon fiber is a relatively easy material to work with and can be cut and shaped with a variety of tools. The most common being high pressure water jet or CNC (Computer Numerical Control) router. In this case a generic 400 mm×600 mm bed 3 axis USB CNC desktop router was utilized. The router bit used was a 3.15 mm solid carbide bit spinning at 24,000 m rpm. To reduce stress on the tool and equipment three cutting passes were made to cut through a 2 mm thickness of carbon fiber plate 12 in even cuts of 0.666 mm per pass. The result from this method is a clean accurate cut matching the initial concept exactly.

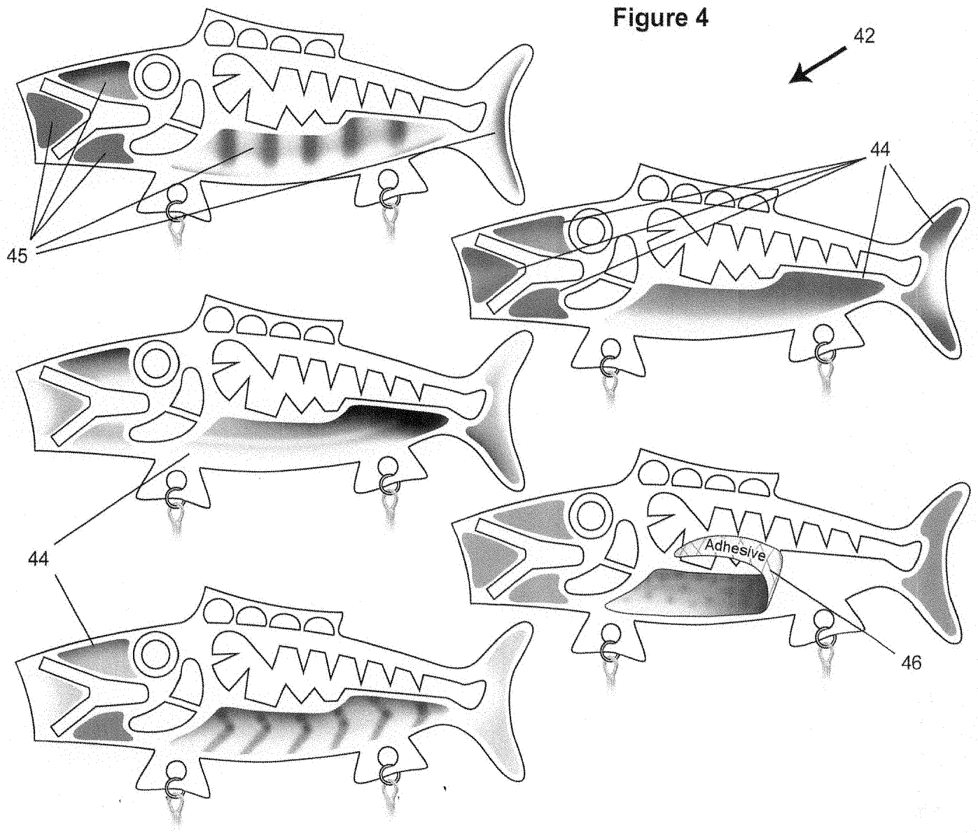

Another optional feature according to the invention is the provision of a sheet or sheets 42 of decals 44 (known per se in fishing lures as in U.S. Pat. No. 6,647,660) which may be provided with the lure 10 when it is sold, or purchased separately, as seen in FIG. 4. Each decal 44 can have characteristics that facilitate use of the lure 10 in various circumstances, and as conventional each decal has a viewed face 45 and an adhesive-containing face 46. The faces 45 of the decals 44 in a sheet 42 can be the same or different, and the shapes of the decals 44 associated with a sheet 42 may also be different. The faces 45 may have colors, reflectivity (including holographic features), and other characteristics that make the lure 10 more desirable to catch certain types of fish, or are provided simply for human aesthetics. As illustrated in FIG. 4 the decals may be provided on the outline of a lure 10 that is the same as the actual lure 10 with which they are used.

While the invention has been herein shown and described in what is presently conceived to be the most practical and preferred embodiment thereof many modifications may be made thereof within the scope of the invention, limited only by the prior art. Note that all general ranges set forth above specifically encompass all narrow ranges within a broad range. For example (and example only) a body 12 thickness of about 1.5-5 mm includes 1.48-2.2 mm, 3.75-5.1 mm, and all other narrow ranges within the broad range.

1. A fishing lure comprising a substantially rigid plate of carbon fiber in a configuration simulating bait for at least one species of fish, at least one hook assembly operatively attached to the carbon fiber plate; and a mechanism that allows connection of the plate to a fishing line.

2. A fishing lure as recited in claim 1 wherein the carbon fiber has a bi-directional/double weave.

3. A fishing lure according to claim 2 wherein the carbon fibers forming the plate have a thickness between about 4 and 12 μm.

4. A fishing lure according to claim 3 wherein the plate has a thickness of between about 1.5-5 mm.

5. A fishing lure according to claim 1 wherein the mechanism that allows connection of the plate to a fishing line comprises an adjustable lip and link assembly for attaching a fishing line; a plurality of openings formed in the plate; and one or more weights attached to the plate in said one or more openings therein.

6. A fishing lure according to claim 1 wherein the mechanism that allows connection of the plate to a fishing line comprises an adjustable lip and link assembly for attaching a fishing line including a substantially V-shaped opening in the front of the plate, and slots in both the upper and lower surfaces defining the opening, the slots dimensioned and configured to hold a lip therein.

7. A fishing lure as recited in claim 1 consisting essentially of said substantially rigid plate of carbon fiber in a configuration simulating bait for at least one species of fish, said at least one hook assembly operatively attached to the carbon fiber plate; and said mechanism that allows connection of the plate to a fishing line.

8. A fishing lure as recited in claim 7 wherein the carbon fiber has a bi-directional/double weave.

9. A fishing lure according to claim 7 wherein the carbon fibers forming the plate have a thickness between about 4 and 12 μm, and wherein the plate has a thickness of between about 1.5-5 mm.

10. A fishing lure according to claim 1 wherein the plate has a configuration of a fish, insect, worm, or cephalopod.

11. A fishing lure according to claim 7 wherein the mechanism that allows connection of the plate to a fishing line comprises an adjustable lip and link assembly for attaching a fishing line; a plurality of openings formed in the plate; and one or more weights attached to the plate in said one or more openings therein.

12. A fishing lure according to claim 7 wherein the mechanism that allows connection of the plate to a fishing line comprises an adjustable lip and link assembly for attaching a fishing line including a substantially V-shaped opening in the front of the plate, and slots in both the upper and lower surfaces defining the opening, the slots dimensioned and configured to hold a lip therein.

13. (canceled)

14. A fishing lure according to claim 1 in association with a sheet of decals having characteristics that can enhance the performance or aesthetics of the lure and are dimensioned to fit on the lure.

15. (canceled)

16. (canceled)

17. (canceled)

18. A fishing lure comprising a plate and a mechanism that allows connection of the plate to a fishing line, the mechanism comprising an adjustable lip and link assembly for attaching a fishing line including a substantially V-shaped opening in the front of the plate, and slots in both the upper and lower surfaces defining the opening, the slots dimensioned and configured to hold a lip therein; and at least one hook assembly operatively attached to the plate.

19. A fishing lure according to claim 18 wherein said lip is held in a slot by an interference fit, friction fit, or one or more mechanical fasteners, and is readily removable therefrom.

20. A fishing lure according to claim 18 wherein said lip is made of material from the group consisting essentially of carbon fiber, metal, plastic, or wood.

21. A fishing lure according to claim 18 further comprising a weight held in the lower slot.

22. A fishing lure comprising: a plate; a mechanism that allows connection of said plate to a fishing line; a plurality of openings formed in the plate; and one or more weights attached to the plate in said one or more openings therein.

23. A fishing lure as recited in claim 22 wherein said one or more weights are attached to the plate in said one or more openings by a friction fit or an interference fit; and wherein the plate has a thickness of between about 1.5-5 mm.

24. A fishing lure according to claim 12 further comprising a weight held in the lower slot.
